(19) United States
(12) Patent Application Publication
(10) Pub. No.: US 2003/0134939 A1
(43) Pub. Date: Jul. 17, 2003

(54) Uv curable composition

(76) Inventors: Aline Vuarnoz, Corserey (CH); Patrick Veya, Morges (CH)

Correspondence Address: SHOEMAKER AND MATTARE, LTD, SUITE 1203, 2001 JEFFERSON DAVIS HIGHWAY, ARLINGTON, VA, 22202, US

(21) Appl. No.: 10/276,336

(22) PCT Filed: Jun. 1, 2001
(86) PCT No.: PCT/EP01/06267

(51) Int. Cl. C03C 17/00; C09D 5/00; C09D 5/29

(52) U.S. Cl. 523/160; 523/161; 523/171

(57) ABSTRACT

The present invention relates to a composition for forming layers on substrates which are removable upon scratching after being curing by UV radiation. The composition comprises film forming components with at least one second organic molecule having at least one epoxy group and at least one second organic molecule having at least one nucleophilic group being crosslinkable with said epoxy group of said first organic molecule upon irradiation with electromagnetic radiation in the ultraviolet range of the electromagnetic spectrum, wherein the weigth ratio (r) of the sum of the film forming components and said substances insoluble in the composition is in the range of between 0.35 to 0.85, preferably between 0.4 and 0.7, even more preferably between 0.45 and 0.6.

The present invention relates to a composition, to the use of a composition for forming layers on substrates which after UV-curing are removable upon scratching, to security documents carrying such layers and to a method for temporarily hiding underlying information on a document according to the preambles of the independent claims.

Scratch off layers are mostly applied to documents in order to temporarily hide underlying information, such as number combinations, symbols, text, etc. One preferred field of applications are their use for lottery tickets.

Scratch off layers have to combine in certain aspects contradictory characteristics. On the one side the dried layers have to show good mechanical resistance to physical damages during manufacturing, shipment and storage in order to fulfil performance and when necessary security aspects. On the other side the layer must be removable by scratching with a coin or fingernail. Thus the adhesion to the underlying substrate and the hardness of the layer must not adversely affect the scratch off properties. In addition, contrary to decals, the adhesive strength of the layer to the underlying substrate must be greater than the cohesive strength within the film. This guarantees that the layer cannot be removed as a whole by a potential forger and reapplied after having read or counterfeited the underlying information.

Compositions adapted for forming scratch off layers, so called abrasion-removable or scratch off compositions, have been already described in DE 3614653, EP 688 838, EP 233 007 and U.S. Pat. No. 5,215,576.

Typical scratch off inks are currently prepared from either polar or apolar elastomeric polymeric resins in benzine-type, or alcohol-type solvents or from dispersions containing to a certain amount water as disperse agent. Due to considerable amount of solvent the inks exhibit a long drying time. The dried ink layers suffer from ageing problems, caused by the reaction of oxygen with unsaturated double bonds which can be present in film-forming resins e.g. in styrene butadiene copolymers which are used in benzine-based and aqueous ink compositions. As a result the resin loses its elastic properties which to a certain extent are necessary for the layer to be scratched off. Consequently the layer is very difficult to scratch after prolonged time of storage. Up to now the problem is solved by adding anti-oxidizing agents to the scratch-off composition. However, anti-oxidants have a short lifetime by themselves and thus the ageing problem is just postponed.

UV curing printing inks are applied in a wide range of applications due to their favourable properties concerning environmental, performance and economy aspects.

Compared to air-dry, ambient-cure systems which employ resins drying by oxypolymerisation or baked systems using thermoset resins, UV curing systems can be produced with a low content of volatile organic carbons (VOC) and thus meeting even strict environmental rules.

In view of performance, UV curing systems are known and highly appreciated for their excellent adhesion to a wide variety of substrates, including metals, laminates, plastics, paper, cardboard, glass, etc.. The cured films exhibit an excellent combination of hardness and flexibility, excellent abrasion and chemical resistance (see EP 799 871), show a very low shrinkage upon curing, have excellent waterproof properties and are odourless after UV cure. Furthermore the high energy efficiency of UV curing systems translates to smaller equipment, less floor space, lower operating costs and lower maintenance expenses. Due to all these advantages there is a constant effort to expand this technology in new fields of applications and new printing processes.

Due to their noteworthy adhesion and hardness, UV curing systems were deemed unsuitable for scratch off layers.

It is the object of the present invention to overcome the drawbacks of the prior art.

In particular it is an object of the invention to provide a scratch off composition curable by electromagnetic radiation in the UV range.

It is a further object of the present invention to provide scratch off layers which do not exhibit a decrease in scratchability with increasing storage time.

It is a further object of the present invention to provide low solvent, low viscous printing inks adapted for forming scratch off layers.

It is a further object of the invention to provide a security document with temporarily hidden information.

These objects are solved by the features of the characterising parts of the independent claims.

In particular the objects are solved by a composition for forming layers on substrates being removable upon scratching after curing, comprising film forming components, at least one photoinitiator, components being insoluble in the composition, additives and optionally at least one solvent. Said film forming components comprise at least one first organic molecule with at least one epoxy group and at least one second organic molecule with at least one nucleophilic group. Said nucleophilic group is crosslinkable with said epoxy group of said first organic molecule upon irradiation with electromagnetic radiation in the ultraviolet (UV) range of the electromagnetic spectrum. The components being insoluble in the composition comprise at least one pigment. The weight ratio (r) of the film forming components to the components in the composition is in the range of between 0.35 to 0.95.

Such a scratch off composition has to be formulated—with regard to optimize the combination of elasticity, fragility and good mechanical resistance of the cured layers.

The fragility of the cured layer which is a requirement for an easy and clean scratching is the consequence of the weight ratio (r) of the crosslinked film forming components and the components insoluble in the composition. The composition can comprise additional insoluble components such as fillers.

When r is increasing, the ratio of the sum of film forming components versus the sum of the insoluble components increases, and the cured layer is getting more and more difficult to scratch off properly: it peals off in its entirety comparable to a decal. When r is decreasing the cured layer is too easily scratched off and thus the risk of damage during production, handling and storage is too high. Summarized both effects adversely affect the hiding capacity of the cured layer.

The term “film” is defined according to DIN EN 971-1:1996-09 and stands for a coherent coating, which is formed by the application of one or more layers on an underlying substrate.

The term “film forming components” is defined according to DIN 55945:1996-09 and indicate those components of the composition which participate in forming a coherent film.

The term “film forming” according DIN 55945:1996-09 is the generic term for the transition of an applied coating from the liquid to the solid state. Film forming is the result of physical drying by penetration of liquid components in the underlying substrate and/or evaporation of volatile components and/or chemical curing. All processes can perform exclusively or simultaneously or one after the other depending on the drying/curing mechanism and the type of substrate.

Although the physical drying of the film forming components should not be excluded in total, the main film forming reaction in the context of the present invention is based on chemical curing, i.e. crosslinking of functional groups upon irradiation with wavelength in the UV-range of the electromagnetic spectrum. In particular the film forming process in the present invention is mainly caused by UV induced cationic polymerisation.

Substances insoluble in the composition are mainly fillers and pigments.

The term “filler” is defined according to DIN 55943:1993-11 and DIN EN 971-1:1996-09. Filler is a substance in granular or pulverized form, which is insoluble in the other components of the coating composition and is used to provide or influence certain physical properties of the overall composition.

The term “pigment” is to be understood according to the definition given in DIN 55943:1993-11 and DIN EN 971-1:1996-09. Pigments are colouring materials in powder or flake form which are—contrary to dyes—not soluble in the surrounding medium. Functional pigments such as magnetic-, corrosion inhibiting- and/or electroconductive pigments may be employed as well.

In the context of the present invention the term “powder pigment” stands for all those pigments with irregular shape and contour. Irregular shape is to be understood as the contrary to flake pigments. Flake pigments have first and second parallel planar surfaces which allows a parallel orientation of the entire pigment to the surface of the underlying substrate and to other flake pigments. Mostly the flakes are produced from sheets which are comminuted to the desired flake size, and thus causing only the edges, i.e. the sides perpendicular to the first and second surfaces to be of irregular contour. The pigment orientation is the result of the drying process of the coating composition (see Römp Lack-und Druckfarben, ed.: U. Zorll, Georg Thieme verlag, Stuttgart 1988, p. 451/452).

Suitable for the composition of the present invention are both: powder and flake pigments. Particularly preferred powder pigments are white and black pigments.

In case powder pigments are incorporated in the scratch off composition of the present invention, r-values in the range of 0,4 to 0,7, particularly in the range of between 0,48 to 0,65 leading to preferred properties.

Preferred flake pigments in a composition of the present invention are selected from the group consisting of lustre pigments. Lustre pigment is a generic term and comprises metal-effect pigments, interference pigments, e.g. pigments changing colour with viewing angle and pearl lustre pigments. Preferably metal effect pigments and of those particularly aluminium pigments are applied. Scratch off compositions having incorporated flake pigments do show a preferred performance with r-values in the range of between 0,55 to 0,85 and even more preferably in the range of 0,6 to 0,78.

The term “nucleophilic” shall stand as generic term for all those functional groups which provide an electron pair for the formation of a new chemical bond.

A further factor influencing the scratchability of the cured layer produced by a composition of the present invention is given by the ratio of the epoxy equivalence to the equivalence of the nucleophilic groups (R):

$$R = \frac{\frac{first organic molecule ( g )}{epoxy eq wt}}{\frac{second organic molecule ( g )}{nucleophilic group eq wt}} = \frac{epoxy eq}{nucleophilic group eq}$$

g=gram; eq=equivalent; wt=weight

Particular good scratch off properties can be achieved by an equivalent ratio R not greater than 5.5.

When R is increasing the ratio of epoxy equivalence particularly versus hydroxy equivalence is increasing, the scratch off ink layer is getting harder to scratch off: it brittles into some dusty material and does not come off the underlying substrate in “one piece”.

By describing the abraded section of the cured layer as coming off in “one piece” it is particularly intended that the dimension of the abraded section is dependent on the dimension of the scratching tools. The dimension e.g. the width of the abraded “cone piece” is defined by the width of the scratching tool used, whereas the length of the abraded “one piece” depends on the scratched distance.

Comparable to the r-values, the R-values are influenced by the type of pigment employed in the composition, too. In case of powder pigments the equivalent ratio of the epoxy groups to the nucleophilic groups (R-values) is in the range of between 1,5 to 4,5, preferably between 2,0 to 4,0 and even more preferably in the range of between 1,5 to 3,5.

Ranges of R-values in case of flake pigments are optimized between 2,0 to 5,4 and preferably between 3,0 to 5,0.

Preferably the second organic molecule contains at least one hydroxyl-group as nucleophilic group, i.e. belongs to the chemical class of polyols. Even more preferably the second organic molecule does not contain other functional groups than hydroxyl groups.

The elasticity of a cured layer provided by a composition of the present invention is mainly dependent on the nature of the polyol.

Favorable to the scratch off properties are weight average molecular weights of the second organic molecule in the range of between 1000 g/mol and 200 g/mol, preferably between 800 g/mol and 250 g/mol.

Particular good properties with regard to the scratchability of the cured layer are achieved by selecting the second organic molecule from the group consisting of aliphatic polyester-polyols, in particular caprolactone-based diols and caprolactone-based triols, polytetrahydrofuran-based diols, polyether-polyols, and in particular polyethylenglycols and polypropylenglycols, further ethoxylated sorbitan, propoxylated sorbitan, ethoxylated sorbitols, propoxylated sorbitols, ethoxylated trimethylolpropane, propoxylated trimethylolpropan, ethoxylated pentaerythritol, propoxylated pentaerythritol.

These diols and triols have been chosen according to their low viscosity. Favorable to the formulation of UV curing scratch-off inks, the viscosity of the polyols does not exceed 500 m Pa.s (Brookfield, 25° C.).

Preferably the weight average molecular weight of the first organic molecule is in the range of between 150 to 500 g/mol, preferably of between 160 to 420 g/mol and even more preferably of between 200 to 380 g/mol.

In a further preferred embodiment of the present invention the first organic molecule is selected from the group consisting of aliphatic epoxy monomers, cycloaliphatic epoxy monomers and/or oligomers. Particularly preferred are glycidylethers as those supplied by WITCO and/or polytetrahydrofuranglycidylethers as those supplied by EMS, 3,4-epoxycyclohexylmethyl-3,4-epoxycyclohexane and/or bis-(3,4-epoxycyclohexyl)adipate as those supplied by UCAR.

In a preferred embodiment of the present invention the fillers and/or pigment have low oil-absorption values. Low oil-absorption values are favourable in keeping the viscosity of the overall composition as low as possible. Low viscosity is a prerequisite for many application techniques, such as printing processes, spraying, brushing, roll coating. In particular the oil-absorption value may not exceed 18 g/100 g, preferably not exceed 14 g/100 g and even more preferably does not exceed 13 g/100 g.

The photoinitators which are applied in a composition of the present invention are selected from the class of aryliodonium, arylsulfonium and isopropylthioxanthone compounds of the following formulas:

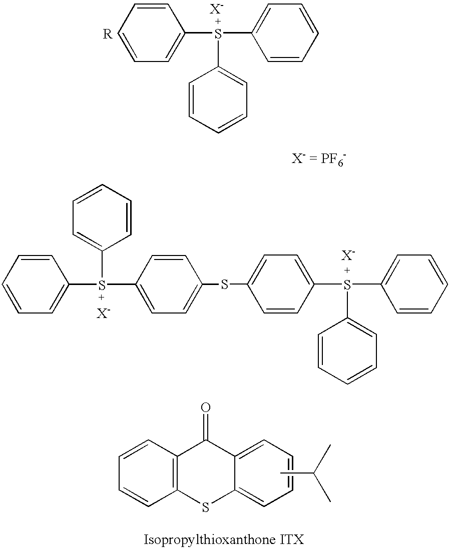

R=H, alkyl-group with C=1 to 5

These compounds are highly thermally stable and upon irradiation liberate strong Broensted acids of the HX type which are capable of initiating subsequently the cationic polymerisation of the oxiran (epoxy) rings. The polymerisation is initiated by the formation of a carbonium ion under the influence of the Broensted acid. The carbonium ion can react under chain propagation with further oxiran (epoxy) rings, and/or with double bonds present in α-position to an oxygen atom and/or with nucleophilic groups, preferably with hydroxy groups of the second organic molecule.

Vinylether monomers which have oxygen atoms in α-position are known to be reactive under UV radiation with molecules containing epoxy groups.

In the context of the present invention their admixture to the epoxy content results in increased cure speed, but should not exceed 20 to 25 weight-% of the total weight of the epoxy molecules.

In spite of rather high filler and/or pigment content the vinylethers develop their cure speeding effects, even under the condition that the weights-% of the vinylethers are not exceeding 5 weight-% of the weight of the overall composition.

The solvents suitable for a composition of the present invention may be present in an amount not exceeding 10% of the weight of the overall composition. They are added to adjust the final viscosity of the composition to the application method. The solvents employed are selected from the class of volatile organic solvents, preferably of the polar type but not having functional groups which are reactive towards the film forming components. Examples of solvents are diethylenglycoldimethylether, dialkyl glycols, alkyl glycolesters or any aprotic solvent.

Since cationic polymerisation is very sensitive to humidity, humidity must be kept as low as possible.

Additional IR-driers can be added to the composition to improve drying speed.

In a preferred embodiment of the present invention the composition is a printing ink and as such its viscosity may not exceed 2.0 Pa.s, preferably not exceed 1.6 Pa.s and even more preferably not exceed 1.3 Pa.s when measured at 20° C., and the solvent content being limited to 10 weight % of the overall composition, preferably less than 5 weight %. Most of the printing processes such as flexo-, gravure-, screen printing need rather low viscosities.

The composition of the invention further comprises additives as they are usually employed such as surfactants, passive resins, i.e. macromolecules which are not reactive with the film forming components, rheology modifiers, waxes, soluble dyes, synergists, etc..

Part of the present invention is further the use of a composition for forming layers on substrates which—after curing—are removable upon scratching and curable upon irradiation with electromagnetic radiation in the UV-range of the electromagnetic spectrum. Such a composition comprises 10 -25 weight %, preferably 10 to 20 weight-% of a first organic molecule having at least one epoxy group, 3 to 20 weight-%, preferably 8 to 15 weight-% of a second organic molecule having at least one, preferably two hydroxyl-groups and 40 to 70 weight-%, preferably 50 to 65 weight-% of substance insoluble in the composition, particularly pigments and/or fillers.

The use of such a composition is particularly preferred in combination with one or more of the features and embodiments of the present invention as described hereinbefore.

A composition of the present invention is particularly suitable for a security document which comprises at least one scratchable UV-cured layer for temporarily hiding underlying information. In the context of the present invention the term security document shall stand for all those documents containing information which shall not be assessable to unauthorised persons. Usually the authorisations in this field of application are acquired by paying a certain amount of money, e.g. purchasing lottery tickets. Compositions of the present invention are further employed for advertisement reasons or product promotion. As one example encapsulated fragrancies to be promoted may be blended into a composition of the present invention and the fragrance is set free upon scratching.

A cured layer produced by a composition of the present invention is resistant to ageing effects adversely affecting the scratchability of the cured layer. Thus (security) documents comprising a cured layer produced by a composition of the present invention can be stored at least one year and in most cases remain scratchable during more than three years under standard conditions (25° C.±5° C.; 65%±15% humidity).

Part of the present invention is further a method for temporarily hiding underlying information on a document comprising the following steps:

a) providing a composition with the features described hereinbefore, particularly A composition for forming layers on substrates being removable upon scratching after curing, comprising film forming components, at least one photoinitiator, components being insoluble in the composition, additives and optionally at least one solvent, characterized in that said insoluble components comprise at least one pigment and said film forming components comprise at least one first organic molecule having at least one epoxy group and at least one second organic molecule having at least one nucleophilic group being cross-linkable with said epoxy group of said first organic molecule upon irradiation with electromagnetic radiation in the ultraviolet range of the electromagnetic spectrum, wherein the weight ratio of the film forming components to the insoluble components is in the range of between 0.35 to 0.95.

b) optionally applying a release varnish which in a preferred embodiment is UV-curing itself, to the part of the document on which the scratch off printing ink will be applied;

c) applying the printing ink provided in step a) either on top of the release varnish applied in step b) or directly to the underlying document, preferably by a flexo-, screen printing- or gravure-printing process, in order to hide the underlying information;

d) curing of the printing ink layer applied in step c) by irradiation with light having wavelengths in a range of between 240 nm and 420 nm. The irradiation should be at least for 0,25-0,5 s at 25° C., in case the irradiation takes place at higher temperatures the irradiation length will be shortened correspondingly. Temperature and irradiation duration depend on the ratio and nature of the film forming components and on the solvent.

e) removing the cured layer of step d) by scratching with a scratching tool such as a coin and fingernail.

Part of the present invention is further a cured layer on a substrate produced with a composition being cross-linked by radiation in the ultraviolet range of the electromagnetic spectrum after application to the substrate for temporarily hiding underlying information and for revealing said information upon scratching.

The present invention will be further illustrated by the following examples and by the drawings:

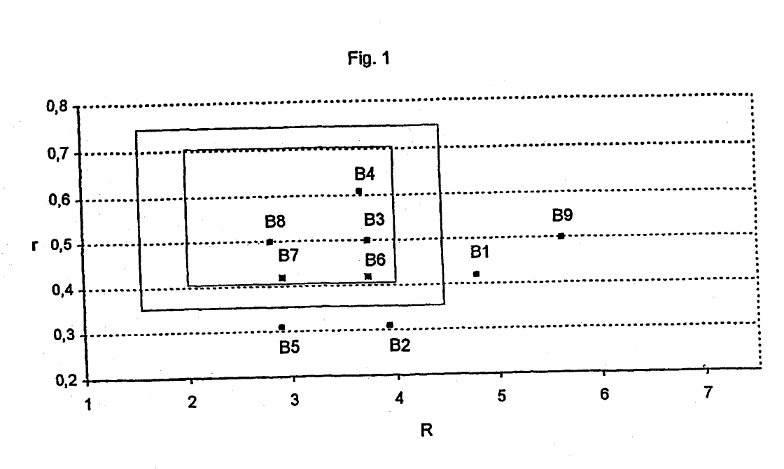

FIG. 1 is a graphical illustration of the r- and R-values of the formulations B1-B9,

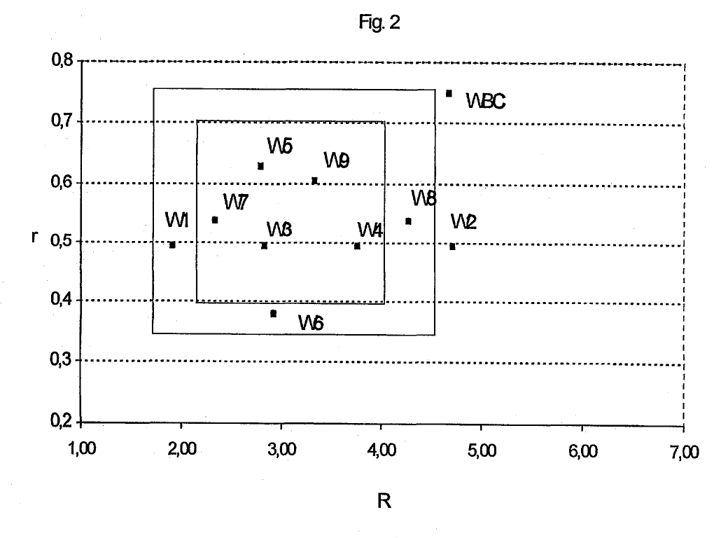

FIG. 2 is a graphical illustration of the r- and R-values of the formulations W1-W9 and WBC,

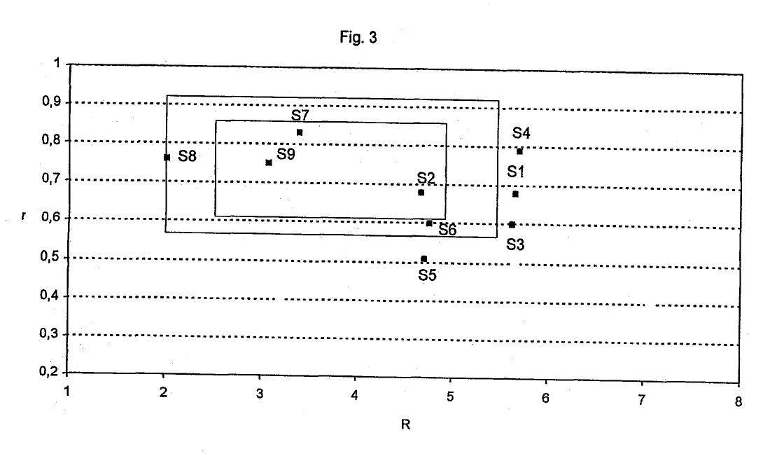

FIG. 3 is a graphical illustration of the r- and R-values of the formulations S1-S9.

### EXAMPLES

For each UV-curing scratch-off ink-black (B1-B9), white (W1-W9; WBC) and silver (S1-S9)—a plurality of examples have been formulated with different ratios R and r. In order to identify the limited domain of R and r each example was printed, dried and evaluated with respect to print quality, covering, drying efficiency, scratch-off properties.

The selection of the monomers and the ratio r and R are determined by the following tests:

Test for Momoner's Compatibility with other Components in the Ink:

The monomer's compatibility with other components in the ink is tested by formulating the ink and checking for general problems such as solubility of additives with the monomers, printing quality, pigments wetting, separation on storage, etc.

Drying Test:

The drying is evaluated by applying a thumb to the surface, turning right and left with a force of 3 kg±0.5 kg applied on the area of the layer covered by the thumb. If no marks are left on the surface derived from the thumb, the drying is good. The test is made immediately after the UV-drying and repeated 24 hours after.

Scratching Test:

Using a fingernail or a coin, the scratch must be easy and clean. The scratch-off ink must come off in one piece like rubber. The ink should not be brittle.

Scratch Resistance Test:

The scratch-off ink surface must be enough resistant to physical damages during printing, cutting, handling or packaging operations.

Delamination Test:

By attempting to remove and replace the scratch-off ink layer by using adhesive tape for example, enough ink should remain on the release varnish in order to protect the variable information underneath.

Ageing Test:

The scratch-off ink layer must be easily scratched-off even after one month at 60° C.

For all formulations it has been found that, when R is increasing, the ratio of epoxy equivalent versus polyol equivalent monomers/oligomers is increasing, the scratch-off ink layer is getting harder to scratch-off: it brittles into some unpleasant dusty material. On the other hand, when R is decreasing the ratio of epoxy equivalent versus polyol equivalent monomers/oligomers is closer to 1,0, the scratch-off ink layer is getting more and more elastic. But, when the concentration of polyols monomers is too high the ink does not dry properly.

When r is increasing, the ratio of the total mass of epoxy and polyol monomers/oligomers versus filler/pigment is increasing, the scratch-off ink layer is getting more and more difficult to scratch-off properly: it peels off in one very elastic piece. This has dramatic consequences on security requirements when attempting to fraud lottery tickets using adhesive tape: the ink layer is easily removed and put on again. On the other hand, when r is decreasing, the scratch-off layer is too easily scratched-off, and damaged already during printing and manufacturing operations.

In the FIGS. 1 to 3 which are the graphical illustrations of the examples (FIG. 1: B1-B9; FIG. 2: W1-W9 and WBC; FIG. 3: S1-S9), those formulations showing good properties with regard to the test described hereinbefore are enclosed by the inner square. The formulations which give still acceptable results are included in the outer square.

### EXAMPLES B1-B9

Black UV-curing Scratch-off Inks:

| | B1 | B2 | B3 | B4 | B5 | B6 | B7 | B8 | B9 |
|---|---|---|---|---|---|---|---|---|---|
| | R = 4.79 | R = 3.93 | R = 3.74 | R = 3.68 | R = 2.90 | R = 3.74 | R = 2.92 | R = 2.81 | R = 5.63 |
| Examples | r = 0.42 | r = 0.31 | r = 0.50 | r = 0.61 | r = 0.31 | r = 0.42 | r = 0.42 | r = 0.50 | r = 0.50 |
| Solsperse 24000SC | 3.1 | 3.1 | 3.1 | 3.1 | 3.1 | 3.1 | 3.1 | 3.1 | 3.1 |
| Cyracure UVR-6110 | 17.6 | 17.6 | 17.6 | 17.6 | 17.6 | 17.6 | 17.6 | 17.6 | 17.6 |
| Cyracure UVR-6105 | 59.1 | 49.1 | 64.1 | 69.1 | 44.1 | 59.1 | 54.1 | 59.1 | 74.1 |
| Sonderruss 30 | 19.7 | 19.7 | 19.7 | 19.7 | 19.7 | 19.7 | 19.7 | 19.7 | 19.7 |
| Cyracure UVR-6128 | 69.1 | 49.1 | 69.1 | 79.1 | 44.1 | 59.1 | 54.1 | 59.1 | 79.1 |
| Eurepox RV-H | 34.7 | 19.7 | 34.7 | 44.7 | 14.7 | 29.7 | 24.7 | 29.7 | 39.7 |
| PolyTHF-650 | 76.7 | 71.7 | 101.7 | 116.7 | 86.7 | 91.7 | 106.7 | 121.7 | 76.7 |
| Cyracure UVI-6990 | 78.0 | 78.0 | 78.0 | 78.0 | 78.0 | 78.0 | 78.0 | 78.0 | 78.0 |
| Barium sulphate | 589.0 | 639.0 | 559.0 | 519.1 | 639.0 | 590.0 | 589.0 | 559.0 | 559.0 |
| Diethylenglycol | 50.0 | 50.0 | 50.0 | 50.0 | 50.0 | 50.0 | 50.0 | 50.0 | 50.0 |
| dimethylether | | | | | | | | | |
| Byk 307 | 1.0 | 1.0 | 1.0 | 1.0 | 1.0 | 1.0 | 1.0 | 1.0 | 1.0 |
| Dow Corning Additive 57 | 2.0 | 2.0 | 2.0 | 2.0 | 2.0 | 2.0 | 2.0 | 2.0 | 2.0 |
| Total | 1000.0 | 1000.0 | 1000.0 | 1000.0 | 1000.0 | 1000.0 | 1000.0 | 1000.0 | 1000.0 |

Preparation:

The 4 first components, Solsperse 24000SC, Cyracure UVR-6110 and 6105 and pigment Sonderuss 30, were mixed and ground three times on a three-roll-mill. The pigment paste was then dispersed with the other components using a lab-mixer (Dispermat). Solsperse 24000SC is an efficient dispersing medium for UV-curable inks. It improves pigment dispersion and decreases the ink viscosity. Sonderuss 30 is a special black pigment for UV-curable ink. Cyracure UVI-6990 is a triaryl-sulfonium photoinitiator which contains a hexafluorophosphate anion. Blanc fixe N is a barium sulfate filler with low oil absorption values. The diethylenglycol dimethylether is used to keep the final viscosity as low as required. BYK 307 is a defoaming agent and Dow Corning 57 is a slipping agent.

Example B3 has a final viscosity of 1.10 Pa·s. The inks were tested on a flexographic press over two layers of a UV-curable release varnish.

As can be seen from FIG. 1 the r and R values for black UV scratch off ink giving good results are from r=0.41 to 0.75, especially from 0.42 to 0.61, in particular in combination with R=2.0 to 4.0.

### EXAMPLES W1-W9

White UV-curing Scratch-off Inks:

| | W1 | W2 | W3 | W4 | W5 | W6 | W7 | W8 | W9 | WBC |
|---|---|---|---|---|---|---|---|---|---|---|
| | R = 1.91 | R = 4.71 | R = 2.83 | R = 3.76 | R = 2.79 | R = 2.92 | R = 2.33 | R = 4.27 | R = 3.33 | R = 4.67 |
| Examples | r = 0.495 | r = 0.495 | r = 0.49 | r = 0.49 | r = 0.63 | r = 0.38 | r = 0.54 | r = 0.54 | r = 0.60 | r = 0.75 |
| Solsperse 24000SC | 3.9 | 3.9 | 3.9 | 3.9 | 3.9 | 3.9 | 3.9 | 3.9 | 3.9 | 8.0 |
| Cyracure UVR-6110 | 62.0 | 100.0 | 80.0 | 90.0 | 100.0 | 70.0 | 75.0 | 100.0 | 110.0 | 102.0 |
| Cyracure UVR-6128 | | | | | | — | — | — | — | 156.0 |
| TiO2 | 280.0 | 280.0 | 280.0 | 280.0 | 280.0 | 300.0 | 280.0 | 280.0 | 280.0 | 495.0 |
| PolyTHF-650 | 160.0 | 97.0 | 132.0 | 112.0 | 155.0 | 107.0 | 155.0 | 110.0 | 137.0 | 106.0 |
| Cyracure UVR-6105 | 65.0 | 90.0 | 75.0 | 85.0 | 80.0 | 60.0 | 75.0 | 95.0 | 80.0 | 80.0 |
| Barium sulphate | 300.0 | 300.0 | 300.0 | 300.0 | 252.0 | 330.0 | 282.0 | 282.0 | 260.0 | 252.0 |
| Isopropylthioxanthone ITX | 7.1 | 7.1 | 7.1 | 7.1 | 7.1 | 7.1 | 7.1 | 7.1 | 7.1 | 8.0 |
| Cyracure UVI-6990 | 70.0 | 70.0 | 70.0 | 70.0 | 70.0 | 70.0 | 70.0 | 70.0 | 70.0 | 74.0 |
| n-Propanol | | | | | | — | — | — | — | 43.0 |
| Diethylenglycol | 50.0 | 50.0 | 50.0 | 50.0 | 50.0 | 50.0 | 50.0 | 50.0 | 50.0 | — |
| dimethylether | | | | | | | | | | |
| Dow Corning Additive 57 | 2.0 | 2.0 | 2.0 | 2.0 | 2.0 | 2.0 | 2.0 | 2.0 | 2.0 | 8.0 |
| Total | 1000.0 | 1000.0 | 1000.0 | 1000.0 | 1000.0 | 1000.0 | 1000.0 | 1000.0 | 1000.0 | 1000.0 |

WBC: white base coat from UCAR (Cyracure: cycloaliphatic epoxides, p.31, 1995).

However, WBC with R=4.71 and r=0.75 was very difficult, almost impossible to scratch off.

The preparation of the W1-W9 and WBC was performed as for the examples B1-B9. The viscosity for formulation W3 was 1.75 Pa·s.

FIG. 2 is the graphical illustration of the r and R ranges of the examples. An r-range of between 0.4 and 0.7 leads to favorable properties in particular in combination with an R-range of between 2.0 and 4.0. Still acceptable results are obtained with r-ranges of 0.35 to 0.75 particularly in combination with R-ranges of between 1.5 to 4.

### EXAMPLES S1-S9

Silver UV-curing Scratch-off Inks:

| | S1 | S2 | S3 | S4 | S5 | S6 | S7 | S8 | S9 |
|---|---|---|---|---|---|---|---|---|---|
| | R = 5.66 | R = 4.67 | R = 5.63 | R = 5.70 | R = 4.71 | R = 4.76 | R = 3.39 | R = 2.01 | R = 3.07 |
| Examples | r = 0.68 | r = 0.68 | r = 0.60 | r = 0.79 | r = 0.51 | r = 0.60 | r = 0.83 | r = 0.756 | r = 0.75 |
| Silvet 320-20-J | 50.0 | 50.0 | 50.0 | 50.0 | 50.0 | 50.0 | 50.0 | 50.0 | 50.0 |
| Cyracure UVR-6110 | 150.0 | 125.0 | 140.0 | 160.0 | 116.0 | 130.0 | 130.0 | 96.0 | 116.0 |
| Cyracure UVR-6105 | 100.0 | 100.0 | 90.0 | 113.0 | 80.0 | 88.0 | 103.0 | 76.0 | 96.0 |
| PolyTHF-650 | 106.0 | 121.0 | 98.0 | 115.0 | 100.0 | 110.0 | 165.0 | 206.0 | 166.0 |
| TiO2 | 100.0 | 100.0 | 100.0 | 100.0 | 100.0 | 100.0 | 100.0 | 100.0 | 100.0 |
| Cyracure UVI-6990 | 70.0 | 71.0 | 70.0 | 70.0 | 70.0 | 70.0 | 70.0 | 70.0 | 70.0 |
| Barium sulphate | 372.0 | 372.0 | 400.0 | 340.0 | 432.0 | 400.0 | 330.0 | 350.0 | 350.0 |
| Diethylenglycol | 50.0 | 50.0 | 50.0 | 50.0 | 50.0 | 50.0 | 50.0 | 50.0 | 50.0 |
| dimethylether | | | | | | | | | |
| Dow Corning Additive 57 | 2.0 | 2.0 | 2.0 | 2.0 | 2.0 | 2.0 | 2.0 | 2.0 | 2.0 |
| Total | 1000.0 | 1000.0 | 1000.0 | 1000.0 | 1000.0 | 1000.0 | 1000.0 | 1000.0 | 1000.0 |

Due to the particular pigment, the final viscosity of the silver ink was limited to 2 Pa·s out of reasons of printability (the higher the viscosity, the smaller r). The inks with a viscosity lower 2 Pa·s but with a R ratio higher than 5.0 are too hard to scratch off. For the silver ink R is kept between 2.0 and 5.0.

For excellent results ranges of r are between 0.6 and 0.85 in particular in combination with R-ranges of between 2.5 and 4.7.

Still acceptable results are achieved with r beginning at 0.57 to 0.93 particularly in combination with an R-value ranging to 5.5 and starting at 2.0.

1. Use of a coating composition for forming a scratch-off layer on a substrate to temporarily hide information on that substrate which information will become visible upon removal of said layer, which composition comprises
a. film forming components, comprising
i) at least on first organic molecule containing an epoxy-group, and
ii) at least one second organic molecule containing a nucleophilic group
said second organic molecule being crosslinkable with said first organic molecule through chemical reaction of nucleophilic and epoxy groups;
b. components being insoluble in said coating composition, said components comprising at least one pigment;
c. at least one photo initiator to initiate said reaction between said first and second organic molecule upon irradiation with electromagnetic radiation preferably in the ultraviolet range;
d. optionally, further additives, and
e. optionally, solvent
wherein the weight ratio (r) of said film forming components to said insoluble components is in the range of between 0.35 to 0.95, said composition to be cured by reaction of said first and second organic molecule to form said layer.

2. Use of a composition according to claim 1, wherein the ratio of the epoxy equivalents to the equivalents of the nucleophilic groups is not exceeding 5.5.

3. Use of a composition according to claim 1 or 2, wherein the pigment is selected from the group consisting of powder pigments, in particular black and white powder pigments.

4. Use of a composition according to claim 3, wherein said r-value is in the range of 0.4 to 0.7, preferably in the range of between 0.48 to 0.65.

5. Use of a composition according to claim 3, wherein the equivalent ratio of said epoxy groups to said nucleophilic groups is in the range of between 1.5 to 4.5, preferably between 2.0 to 4.0 and even more preferably in the range of between 2.5 to 3.5.

6. Use of a composition according to one of the claims 1 to 2, wherein the pigment is selected from the group consisting of flake pigments having first and second parallel planar surfaces.

7. Use of a composition according to claim 6, wherein said flake pigment is a lustre pigment.

8. Use of a composition according to claim 7, wherein said lustre pigment is a metal effect pigment, particularly an aluminium pigment.

9. Use of a composition according to one of the claims 6 to 8 wherein said r-value is in the range of between 0.55 to 0.85, preferably in the range of 0.6 to 0.78.

10. Use of a composition according to one of the claims 6 to 9 wherein the equivalent ratio of said epoxy groups to said nucleophilic groups is in the range of between 2.0 to 5.4, preferably in the range of between 3.0 to 5.0.

11. Use of a composition according to one of the claims 1 to 10, wherein said second organic molecule comprises at least one hydroxy-group as the nucleophilic group.

12. Use of a composition according to one of the claims 1 to 11, wherein the molecular weight of said first organic molecule is in the range of between 150 g/mol and 500 g/mol, preferably between 160 g/mol and 420 g/mol and even more preferably in the range of between 290 g/mol and 380 g/mol.

13. Use of a composition according to one of the claims 1 to 12, wherein said first organic molecule is selected from the group consisting of aliphatic epoxy monomers, cycloaliphatic epoxy monomers, aliphatic epoxy oligomers and cycloaliphatic oligomers.

14. Use of a composition according to one of the claims 1 to 13 wherein the weight average molecular weight of said second organic molecule is in the range of 200 g/mol to 1000 g/mol.

15. Use of a composition according to one of the claims 1 to 14 wherein said second organic molecule is selected from the group consisting of aliphatic polyester polyols, in particular polytetrahydrofurane-based diols, caprolactone-based diols, caprolactone-based triols, polyether-polyols, in particular polyethylene glycols and polypropylene glycols.

16. Use of a composition according to one of the claims 1 to 15, wherein said photoinitiator is capable of initiating a cationic polymerization mechanism and is selected from the group consisting of aryl-sulfonium and aryl-iodonium salts and isopropylthioxanthone and their derivatives.

17. Use of a composition according to one of the claims 1 to 16, wherein said further additives comprise at least one accelerator having a double bond in α-position to an oxygen atom, particularly at least one vinyl ether.

18. Use of a composition according to one of the claims 1 to 17, wherein said coating composition is a printing ink.

19. Use of a composition according to one of the preceding claims, said coating composition being characterized in that its viscosity is not exceeding 2.0 Pa.s, preferably not 1.6 Pa.s and even more preferably not exceeding 1.3 Pa.s at 20° C., and that its solvent wt. % is not exceeding 10 wt. % of the weight of the composition.

20. Use of a composition for forming layers on substrates removable upon scratching and curable upon irradiation with wavelengths in the ultraviolet range of the electromagnetic spectrum, characterized in that the composition comprises a first organic molecule having at least one epoxy group, a second organic molecule having at least one nucleophilic group, preferably at least one hydroxyl-group, and at least one further substance which is insoluble in the composition, such as a filler and/or a pigment.

21. Use of a scratch-off layer to temporarily hide information on a substrate, which layer is removable by scratching, and which is produced by application of a coating composition which is cross-linked by irradiation with a wavelength in the UV-range of the electromagnetic spectrum.

22. Use of a composition for forming a scratch-off layer on substrates, said layer being removable by scratching, and said composition compriseing a first organic molecule having at least one epoxy group, a second organic molecule having at least one nucleophilic group, said nucleophilic group being preferably a hydroxyl-group, and at least one further substance being insoluble in said coating composition selected from the group of pigments having substantially parallel and plane surfaces, preferably a lustre pigment, a metal effect pigment or an aluminium pigment.

23. A coating composition for forming a scratch-off layer on a substrate to temporarily hide information on that substrate which information will become visible upon removal of said layer, which composition comprises
a. film forming components, comprising
i) at least on first organic molecule containing an epoxy-group, and
ii) at least one second organic molecule containing a nucleophilic group
said second organic molecule being crosslinkable with said first organic molecule through chemical reaction of nucleophilic and epoxy groups;
b. components being insoluble in said coating composition, said components comprising at least one pigment;
c. at least one photo initiator to initiate said reaction between said first and second organic molecule upon irradiation with electromagnetic radiation, preferably in the ultraviolet range;
d. optionally, further additives, and
e. optionally, solvent
wherein the weight ratio (r) of said film forming components to said insoluble components is in the range of between 0.35 to 0.95, said composition to be cured by reaction of said first and second organic molecule to form said layer,
wherein said coating composition is a printing ink having a viscosity which is not exceeding 2.0 Pa.s, preferably not 1.6 Pa.s and even more preferably not exceeding 1.3 Pa.s at 20° C., and wherein the solvent content of the composition is not exceeding 10 wt. % of the weight of the composition.

24. A composition for use according to claim 1 to 22, characterized in that said pigment is selected from the group consisting of flake pigments having first and second parallel planar surfaces.

25. A composition according to claim 24, characterized in that said pigment comprises a lustre pigment and/or a metal effect pigment, and/or an aluminium pigment.

26. A security document comprising at least one information which is covered by a scratch-off layer and produced according to one the claims 1 to 25.

27. A method for temporarily hiding information on a document, comprising the steps of
a. providing a document having a surface area which carries information;
b. providing a composition according to one of the claims 23 to 25;
c. optionally applying a release varnish to said surface area;
d. printing the composition of step b) over said surface area such as to hide the information it carries;
e. curing the printed composition applied in step d) by irradiation with light having a wavelength in the range of between 240 nm and 420 nm;
f. distributing the document carrying the information-hiding layer of step e) to release said information by scratching-off said layer with a scratching tool.

28. A method for temporarily hiding information on a document comprising the steps of
a. providing a document having a surface area which carries information;
b. optionally applying a release varnish to said surface area;
c. covering said surface area to hide the information it carries using a composition according to one of the claims 1 to 22;
d. curing the information-hiding layer applied in step c) by irradiation with light having a wavelength in the range of between 240 nm and 420 nm;
e. distributing the document carrying the information-hiding layer of step d) to release said information by scratching-off said layer with a scratching tool.
